(19) United States
(12) Patent Application Publication
(10) Pub. No.: US 2006/0087763 A1
(43) Pub. Date: Apr. 27, 2006

(54) Case

(75) Inventors: Keng Hwa Chua, Singapore (SG); Peng Fei Gao, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 11/155,536

(22) Filed: Jun. 17, 2005

Related U.S. Application Data
(60) Provisional application No. 60/580,470, filed on Jun. 17, 2004.
(60) Provisional application No. 60/580,614, filed on Jun. 17, 2004.
(60) Provisional application No. 60/585,415, filed on Jul. 2, 2004.

(51) Int. Cl. G11B 17/00

(52) U.S. Cl. 360/97.01

(57) ABSTRACT

A case (10) for dampening noise generated by a hard disk drive (50), the case (10) comprising: an air-permeable liquid-impervious cover (20) to cover at least an exterior portion (52) of the hard disk drive (50), the exterior portion (52) including a ventilation hole (51) of the hard disk drive (50); wherein an enclosed space (30) is defined between the cover (20) and the exterior portion (52), such that the case (10) dampens the noise generated by the hard disk drive (50) while maintaining ventilation of the hard disk drive (50).

### BACKGROUND OF THE INVENTION

Advances in hard drive technology have improved capacity and seek times. However, the rotational speed has also increased. Typically, hard disk drives are rotating at 7200 rpm which generates significant audible noise. The majority of the noise is channeled through the ventilation hole of the hard disk drive which increases the pitch of the noise to a very noticeable level.

Use of integrated devices, such as a portable audio player comprising a microphone and a hard disk drive, means that the noise problem is recorded by the microphone. A sensitive microphone is able to detect and record the hard disk drive noise and thus diminish the clarity of the recording.

### SUMMARY OF THE INVENTION

In a first preferred aspect, there is provided a case for dampening noise generated by a hard disk drive, the case comprising:
an air-permeable liquid-impervious cover to cover at least an exterior portion of the hard disk drive, the exterior portion including a ventilation hole of the hard disk drive;
wherein an enclosed space is defined between the cover and the exterior portion, such that the case dampens the noise generated by the hard disk drive while maintaining ventilation of the hard disk drive.

A secondary layer may be adhered to the cover.

The cover may be made of a polymeric-foam material. The secondary layer may be made of a polymeric foam material. The secondary layer may have at least one slot. The slot may be selected from the group comprising: inclined-to-the-edge and zig-zag.

The cover may be made of a material selected from: Nitto Denko SCF103 and Poron LE-20.

The cover and the exterior portion may not be in contact so as to define the enclosed space.

The cover may be adhered to the exterior portion by a double-sided adhesive tape.

In a second aspect, there Is provided a method for minimising the recording of noise generated from a hard disk drive, the method comprising:
covering at least an exterior portion of the hard disk drive with an air-permeable liquid-impervious cover, the exterior portion including a ventilation hole of the hard disk drive;
wherein the cover defines an enclosed space between the cover and the exterior portion, such that the cover and the enclosed space dampen the noise generated by the hard disk drive while maintaining ventilation of the hard disk drive.

The method may further comprise positioning a microphone at a distal location to the ventilation hole.

In a third aspect, there is provided a portable media device for playing and recording audio content, the device comprising:
a microphone for recording audio content;
a hard disk drive for storing audio content having a ventilation hole; and
an air-permeable liquid-impervious cover to cover at least an exterior portion of the hard disk drive, the exterior portion including the ventilation hole;
wherein an enclosed space is defined between the cover and the exterior portion, such that the cover and the enclosed space dampen the noise generated by the hard disk drive while maintaining ventilation of the hard disk drive.

The microphone may be located at a distal position to the ventilation hole.

The hard disk drive may be a one inch hard disk drive.

### BRIEF DESCRIPTION OF THE DRAWINGS

An example of the invention will now be described with reference to the accompanying drawings, in which:

FIG. 1 is a sectional view of a case in accordance with the present invention;

FIG. 2 is a process flow diagram of a noise reduction method in accordance with the present invention;

FIG. 3 is a block diagram of the case used In a portable media player device with a microphone; and

FIG. 4 is a top view of a cover in accordance with the present invention.

### DETAILED DESCRIPTION OF THE DRAWINGS

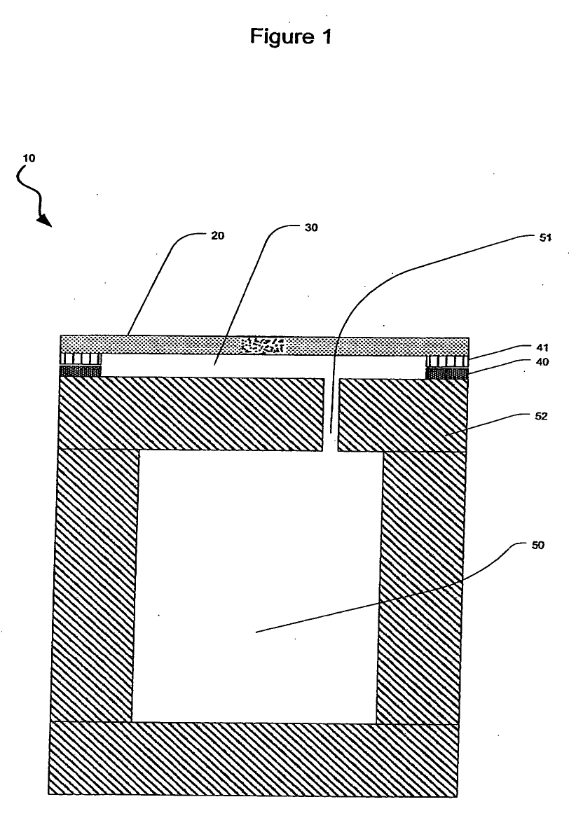

Referring to FIG. 1, a case 10 for dampening noise generated by a hard disk drive 50 is provided. The case 10 comprises an air-permeable liquid-impervious cover 20 to cover at least the ventilation hole 51 of the hard disk drive 50. The cover 20 is adhered to the hard disk drive case 52 by a doublesided adhesive tape 40. The double-sided adhesive tape 40 may offer some sound damping properties. The cover 20 may have a secondary layer 41 adhered to it that may fully extend along the cover 20. The secondary layer 41 may be a strip straddling the perimeter of the cover 20. An enclosed space 30 is defined between the cover 20, the secondary layer 41, and the hard disk drive case 52. The cover 20 and the hard disk drive case 52 are not in contact so as to define the endosed space 30. The case 10 dampens the noise generated by the hard disk drive 50 while maintaining ventilation of the hard disk drive 50.

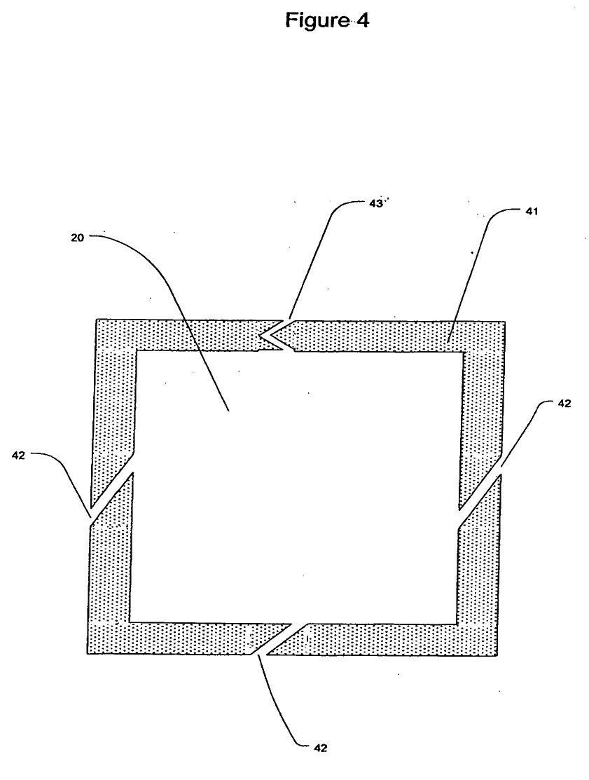

Referring to FIG. 4, the secondary layer 41 may be inclined to the edge 42 or have zig-zag 43 slots incorporated in the layer 41 to enhance air flow from the enclosed space 30 and to absorb energy of sound waves generated from the hard disk drive 50. This allows for air from the enclosed space 30 to escape via these slots 42, 43 in addition to diffusion through the cover 20. The speed of air flow through the slots is insufficient to Induce turbulence and thus does not increase the noise generated.

The cover 20 may be-made from a polymeric foam material. The secondary layer 41 may be made from the same polymeric foam material as the cover 20.

Examples of suitable foam material include SCF103 or Poron LE-20. Poron LE-20is manufactured by Rogers Inoac Corporation and is a high-density micro-cellular urethane foam. Super Clean Foam (SCF103) is manufactured by Nitto Denko Corporation. SCF103 is a polypropylene foam material which comprises three layers: liner, adhesive carrier PET#25 and polypropylene foam. SCF103 is easy to compress, contains almost no impurities and has unique micro-cell structure. The cover 20 absorbs noise generated by the hard disk drive 50 while allowing ventilation of the hard disk drive 50 to continue.

To obtain a desirable reduction of noise, a Poron LE-20 cover 20 is made at least 2 millimeters thick. If Nitto Denko SCF103 is selected for the material of the cover 20, it is made at least 0.5 millimeters thick. The secondary layer 41 may be thicker than the cover 20.

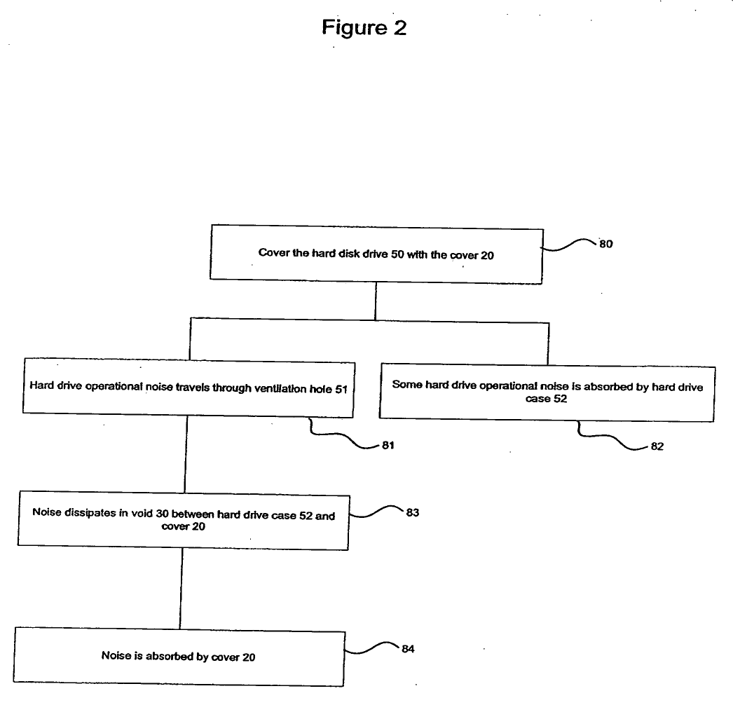

Referring to FIG. 2, the hard disk drive 50 is covered 80 by the cover 20 to enclose at least the ventilation hole 51. A void 30 Is defined between the cover 20 and the hard disk drive case 52. A large proportion of the noise generated by the hard disk drive 50 travels 81 through the ventilation hole 51. Some noise is absorbed 82 by the hard disk drive case 52. Noise emitted via the ventilation hole 51 dissipates 83 in the void 30. The void 30 reduces the pitch and amplitude and the noise. The remaining noise is then absorbed 84 by the cover 20.

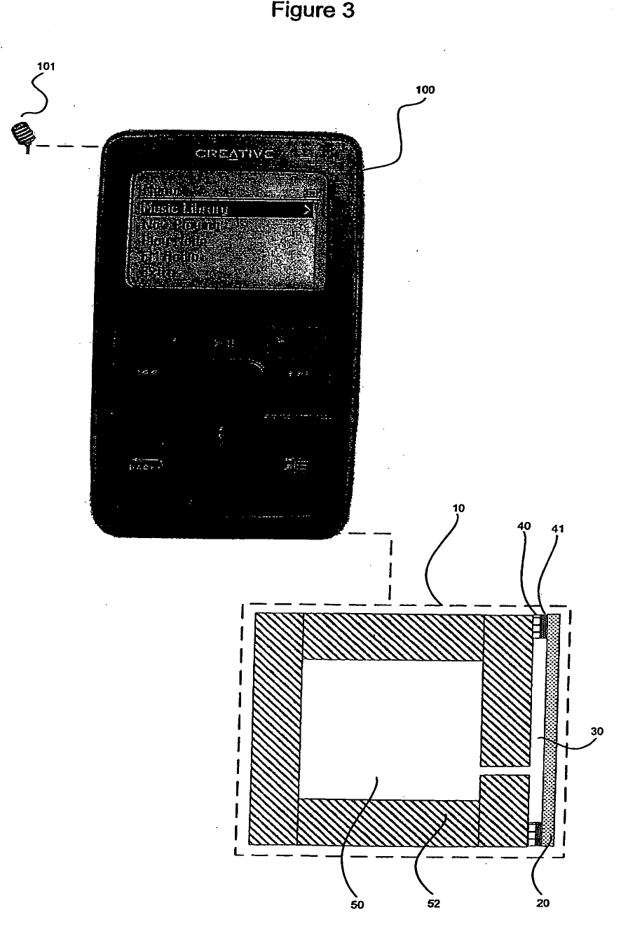

Referring to FIG. 3, an MP3 player device 100 with a hard disk drive 50. The hard disk drive is a one inch hard disk drive to store MP3 files. The hard disk drive 50 may be of any capacity. The MP3 player device 100 also comprises a microphone 101 for voice/audio recording. The hard disk drive 50 is encased in the case 10. To ensure that the microphone 101 does not record any noise generated by the hard disk drive 50, it is positioned as far away from the hard disk drive 50 as possible. Furthermore, the direction of the microphone 101 and the direction of the ventilation hole 51 face away from each other.

Although an MP3 player device 100 has been described, it is envisaged that other portable media player devices may be used including portable video players. A hard disk drive 50 that Is quiet during operation is advantageous for all computing devices in order to achieve a quiet operational environment. Computing devices may include desktop and notebook-computers, mobile phones, or personal digital assistants (PDAs). A quiet operational environment enables recording of audio information with greater clarity and thus subtle sounds which would otherwise be masked by the noise generated by the hard disk drive are able to be detected and recorded.

In another embodiment, the cover 20 may extend to fully enclose the entire hard disk drive case 52. The enclosed space 30 may also extend completely around the hard disk drive case 52. This embodiment provides additional dampening for any noise communicated via other areas of the hard disk drive case 52.

Although an adhesive 40 has been described, it is envisaged that other forms of bonding the cover 20 to the hard disk drive case 52 are possible such as heat bonding, chemical bonding or using fasteners.

In situations where the hard disk drive 50 may have more than one ventilation hole 52, it is advantageous to cover all the ventilation holes 52 with the cover 20 to achieve desirable noise reduction.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A case for dampening noise generated by a hard disk drive, the case comprising:
an air-permeable liquid-impervious cover to cover at least an exterior portion of the hard disk drive, the exterior portion including a ventilation hole of the hard disk drive;
wherein an enclosed space is defined between the cover and the exterior portion, such that the case dampens the noise generated by the hard disk drive while maintaining ventilation of the hard disk drive.

2. The case according to claim 1, further comprising a secondary layer adhered to the cover.

3. The case according to claim 1, wherein the cover is made of a polymeric foam material.

4. The case according to claim 2, wherein the secondary layer is made of a polymeric foam material.

5. The case according to claim 2, wherein the secondary layer has at least one slot.

6. The case according to claim 5, wherein the slot Is selected from the group comprising: inclined-to-the-edge and zigzag.

7. The case according to claim 1, wherein the cover is made of a material selected from: Nitto Denko SCF103 and Poron LE-20.

8. The case according to claim 1, wherein the cover and the exterior portion are not In contact so as to define the endosed space.

9. The case according to claim 1, wherein the cover Is adhered to the exterior portion by a double-sided adhesive tape.

10. A method for minimising the recording of noise generated from a hard disk drive, the method comprising:
covering at least an exterior portion of the hard disk drive with an air-permeable liquid-impervious cover, the exterior portion including a ventilation hole of the hard disk drive;
wherein the cover defines an enclosed space between the cover and the exterior portion, such that the cover and the enclosed space dampen the noise generated by the hard disk drive while maintaining ventilation of the hard disk drive.

11. The method according to claim 10, wherein the cover includes a secondary layer.

12. The method according to claim 11, wherein the secondary layer has at least one slot.

13. The method according to claim 12, wherein the slot is selected from the group comprising: inclined-to-the-edge and zig-zag.

14. The method according to claim 10, further comprising positioning a microphone at a distal location to the ventilation hole.

15. A portable media device for playing and recording audio content, the device comprising:
a microphone for recording audio content;
a hard disk drive for storing audio content having a ventilation hole; and
an air-permeable liquid-impervious cover to cover at least an exterior portion of the hard disk drive, the exterior portion including the ventilation hole;
wherein an enclosed space is defined between the cover and the exterior portion, such that the cover and the enclosed space dampen the noise generated by the hard disk drive while maintaining ventilation of the hard disk drive.

16. The device according to claim 15, wherein the microphone is located at a distal position to the ventilation hole.

17. The device according to claim 15, wherein the hard disk drive is a one inch hard disk drive.

18. The device according to claim 15, wherein the cover includes a secondary layer.

19. The device according to claim 18, wherein the secondary layer has at least one slot.

20. The device according to claim 19, wherein the slot is selected from the group comprising: inclined-to-the-edge and zig-zag.
